(19) United States
(12) Patent Application Publication
(10) Pub. No.: US 2006/0000297 A1
(43) Pub. Date: Jan. 5, 2006

(54) Ambient particulate sampler inlet assembly

(76) Inventors: Robert A. Gussman, Winchester, NH (US); Kevin E. DeVoe, Waltham, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 10/884,450

(22) Filed: Jul. 2, 2004

(51) Int. Cl. G01N 1/24

(52) U.S. Cl. 73/863.22; 73/863.23

(57) ABSTRACT

An ambient particulate sampler assembly including an upper section with a nozzle entry and an impactor nozzle housing removably receiving a single nozzle jet. A lower section is removable from the upper section and includes an impaction chamber with one or more outlets. A set of different size nozzle jets are provided and each is insertable in the impactor nozzle housing to allow the user or manufacturer to selectively choose a particular measuring criteria.

### FIELD OF THE INVENTION

This invention relates to an ambient gas particulate sampler.

### BACKGROUND OF THE INVENTION

Ambient particulate samplers are used to measure particles in the air typically to quantify the pollution level at a specific location. A typical ambient particle sampler includes an inlet assembly defined by an inlet upper section and a “bullet” body or lower section housing an impaction chamber. A sample unit is connected to the bullet body lower section portion of the inlet assembly. Ambient air is drawn into the inlet upper section and through a nozzle jet in the inlet upper section by a vacuum pump located in the sample unit.

The nozzle jet directs the air to the impaction chamber of the lower section. The air then passes through one or more outlets in the bottom impact plate of the impaction chamber and ultimately to the sample unit.

Depending on the particle size of interest and the monitoring plan or set-up, the nozzle jet can be one of a large “TSP” or total suspended particulate nozzle, a “PM 10” or particle measurement 10 (micrometers), a PM 5, or a PM 1 nozzle.

Thus, those skilled in the art have long offered inlet assemblies each fitted with a different size nozzle which requires the user to purchase a different inlet assembly for each particle size of interest. Those skilled in the art have also attempted to configure an inlet assembly with multiple different size nozzle jets each fitted in the inlet assembly but without success. Such multiple jet/multiple nozzle inlet assembles have not been fully tested, were complex, and expensive.

### SUMMARY OF THE INVENTION

It is therefore an object of this invention to provide an ambient particulate sampler assembly which can be fitted with different size nozzle jets by the user or manufacturer allowing the user to selectively choose which particulate measuring criteria best suits the user's requirements.

It is a further object of this invention to provide such a sampler assembly which is accurate, tested, and simple in design.

It is a further object of this invention to provide such an ambient particulate sampler assembly which is inexpensive to manufacture.

The subject invention results from the realization that a reconfigurable ambient particulate sampler is effected by an omnidirectional upper section with an impactor nozzle housing accommodating a single nozzle jet and a set of different size nozzle jets insertable in the impactor nozzle housing allowing the user or manufacturer to selectively choose which particulate measuring criteria best suits the user's requirements.

The subject invention, however, in other embodiments, need not achieve all these objectives and the claims hereof should not be limited to structures or methods capable of achieving these objectives.

This invention features an ambient particulate sampler assembly with an upper section including a nozzle entry and an impactor nozzle housing removably accommodating a single nozzle jet, and a lower section removable from the upper section and including an impaction chamber with one or more outlets. A set of different size nozzle jets are provided each separately insertable in the impactor nozzle housing allowing the user to selectively choose a particular measuring criteria.

Typically, a sample unit is connected to the lower section and, in the preferred embodiment, the sample unit includes a vacuum source for drawing ambient gas into the upper section at a flow rate of 5 liters per minute or approximately 5 liters per minute. In one example, the upper section includes a top plate baffle spaced from a lower baffle plate. In the same example, the lower section impaction chamber includes three outlets and a water conduit. A water trap is connected to the water conduit. The plurality of nozzle jets may include a TSP nozzle jet, a PM 10 nozzle jet, a PM 5 nozzle jet, and/or a PM 1 nozzle jet.

In one embodiment, an ambient particulate sampler inlet in accordance with this invention features an upper section accommodating a single nozzle jet, a lower section removable from the upper section and including an impaction chamber, and a plurality of different size nozzle jets insertable in the upper section. The upper section typically includes a top plate baffle spaced from a lower plate baffle. The lower section impaction chamber typically includes three outlets. In the preferred embodiment, the upper section includes a nozzle entry which receives an impactor nozzle housing including a channel which removably receives one of the nozzle jets.

One particular example of an ambient particulate sampler assembly in accordance with this invention includes an upper section including a nozzle entry connected on one end to a baffle plate assembly and connected on the other end to an impactor nozzle housing. A set of different size nozzle jets are insertable one at a time in the impactor nozzle housing. A lower section is removably connected to the impactor nozzle housing and defines an impaction chamber in fluid communication with an exit conduit. A sampler unit is connected to the exit conduit of the lower section and includes a pump for drawing ambient gas into the upper section at a flow rate of 5 liters per minute or approximately 5 liters per minute. In one example, a filter is located between the sampler unit and the exit conduit of the lower section.

### BRIEF DESCRIPTION OF THE DRAWINGS

Other objects, features and advantages will occur to those skilled in the art from the following description of a preferred embodiment and the accompanying drawings, in which:

FIG. 1 is a schematic three-dimensional view of an example of a complete ambient particulate sampler in accordance with the subject invention;

FIG. 2 is a schematic exploded view showing an example of the inlet assembly portion of the sampler shown in FIG. 1;

FIG. 3 is a schematic three-dimensional view showing the inlet assembly of FIG. 2 from a different perspective;

FIG. 4 is a schematic cross-sectional view of the upper section of the inlet shown in FIGS. 2 and 3;

FIG. 5 is a bottom plan view of the nozzle entry portion of the upper section of the inlet shown in FIG. 4;

FIG. 6 is a schematic cross-sectional view taken a long line 6-6 of FIG. 5;

FIG. 7 is a schematic three-dimensional side view of the impactor nozzle housing shown in FIGS. 2-3;

FIG. 8 is a schematic bottom plan view of the impactor nozzle housing shown in FIG. 7;

FIG. 9 is a schematic cross-sectional view taken a long line 9-9 of FIG. 8;

FIG. 10 is a schematic bottom plan view of the lower section of the inlet shown in FIGS. 2-3;

FIG. 11 is a schematic cross-sectional view taken a long line 11-11 of FIG. 10;

FIG. 12 is a schematic bottom plan view of a PM 17 nozzle jet in accordance with the subject invention;

FIG. 13 is a schematic cross-sectional view taken a long line 13-13 of FIG. 12;

FIG. 14 is a schematic bottom plan view of a PM 10 nozzle jet in accordance with the subject invention;

FIG. 15 is a schematic cross-sectional view taken a long line 15-15 of FIG. 14;

FIG. 16 is a schematic bottom plan view of a PM 2.5 nozzle jet in accordance with the subject invention;

FIG. 17 is schematic cross-sectional view taken a long line 17-17 of FIG. 16;

FIG. 18 is a schematic bottom plan view of a PM 1 nozzle jet in accordance with the subject invention; and

FIG. 19 is a schematic cross-sectional view taken a long line 19-19 of FIG. 18.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

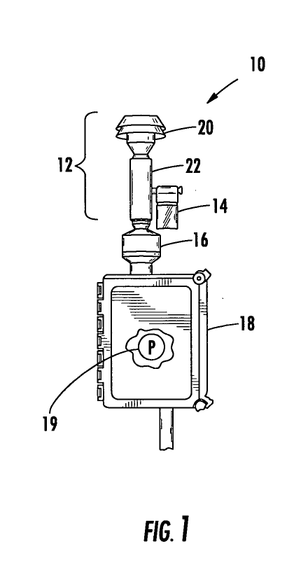

A complete ambient particulate sampler 10, FIG. 1, in accordance with the subject invention, includes omnidirectional inlet assembly 12, filter 16, and sample unit 18. Vacuum pump 19 within sample unit 18 draws ambient air into the upper section 20 of inlet 12 preferably at a flow rate of 5 liters per minute, through a nozzle jet therein, to an impaction chamber in lower section 22, and ultimately to sample unit 18. Water collected in the impaction chamber of lower section 22 is collected in water trap 14.

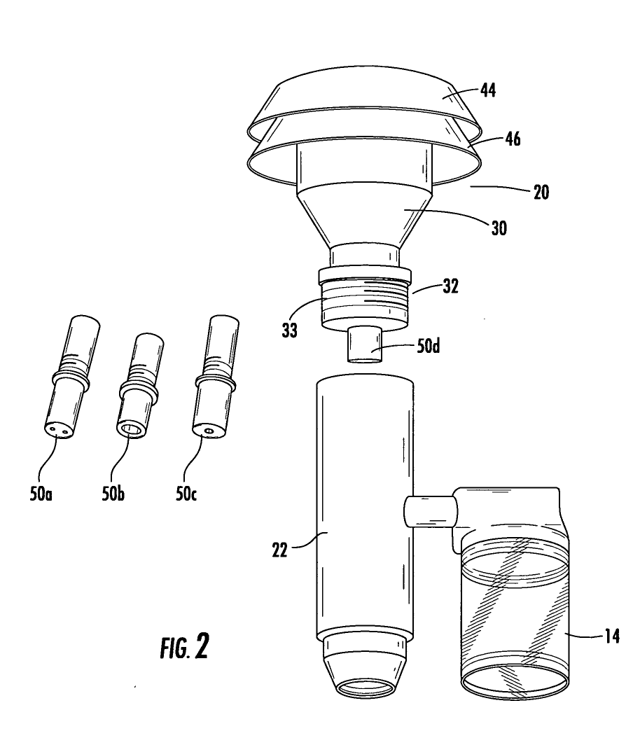

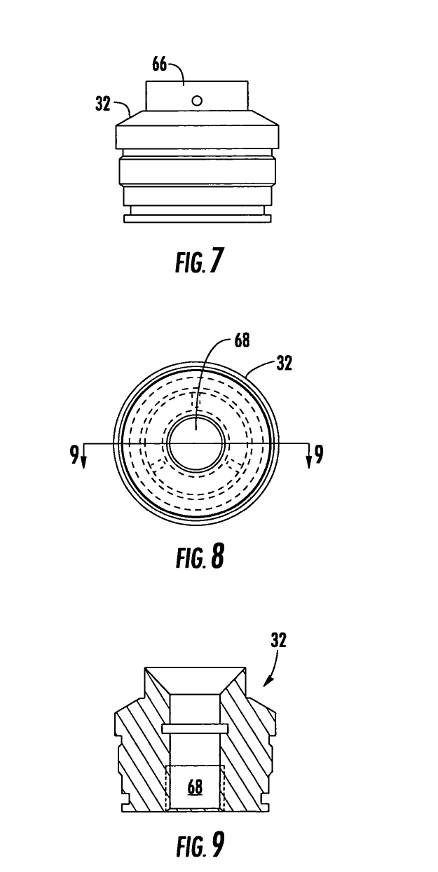

In the preferred embodiment shown in FIGS. 2-3, upper section 20 includes nozzle entry 30 connected to impactor nozzle housing 32 with a single nozzle receiving channel 68 as shown in FIG. 9 for accommodating a single nozzle jet 50d, FIGS. 2-3. Lower section 22, FIG. 3 includes impaction chamber 34 with outlets 36a, 36b, and 36c through impact plate 38. Water conduit 40 provides a pathway for water collected in impaction chamber 34 to be drawn into water trap 14. Nozzle entry 30 is typically connected to baffle assembly 42 including top plate baffle 44 spaced from lower battle plate 46.

Upper section 20 is removable from lower section 22 by threads 33 and 35, and a set of different size nozzle jets 50a, 50b, 50c, and 50d are each insertable in impactor nozzle housing 32, one at a time, allowing the user or manufacturer to selectively choose a particular particulate measuring criteria according to the user's requirements.

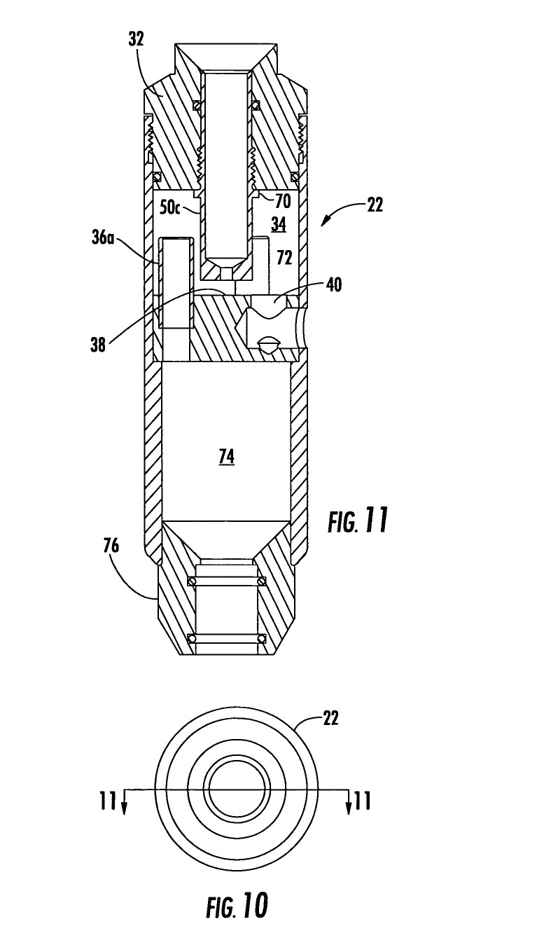

In FIGS. 2-3, TSP or total suspended particulate nozzle 50d is shown inserted (screwed) into impactor nozzle housing 32. But, if the user so desires, TSP nozzle jet 50d can be removed from impactor nozzle housing 32 and replaced with PM 10 nozzle jet 50b, PM 2.5 nozzle jet 50c, or PM 1 nozzle jet 50a. For example, in FIG. 11, PM 2.5 nozzle jet 50c is shown in place in impactor nozzle housing 32. In this way, the particulate sampler inlet assembly of this invention can be fitted with different nozzle jets by the user allowing the user to selectively choose which particulate measuring criteria best suites the user's requirements.

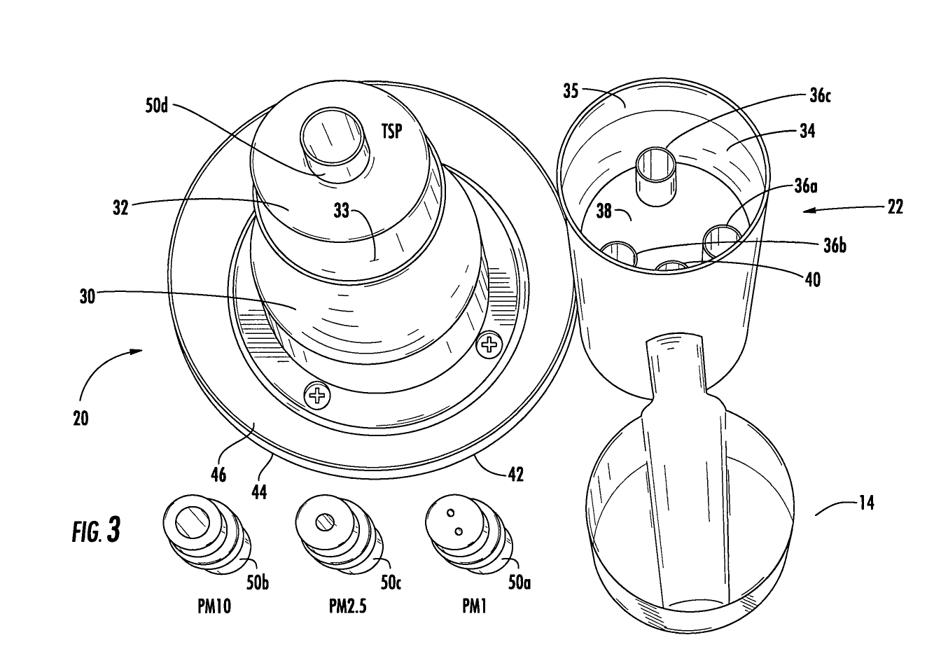

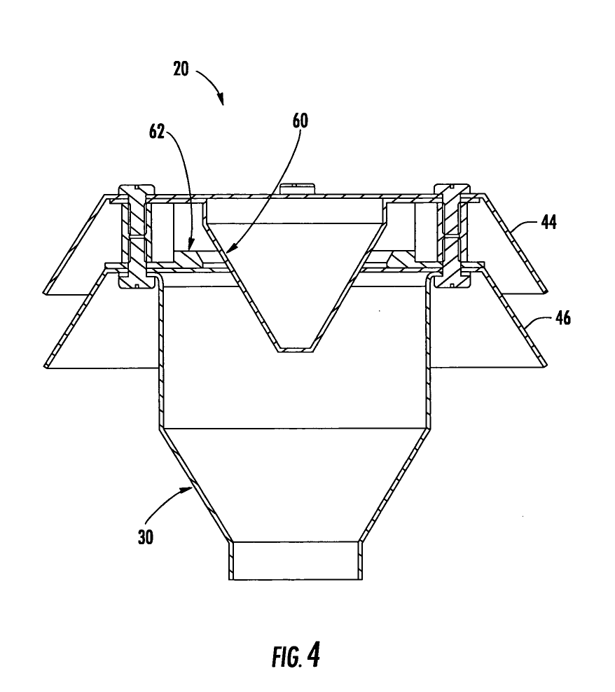

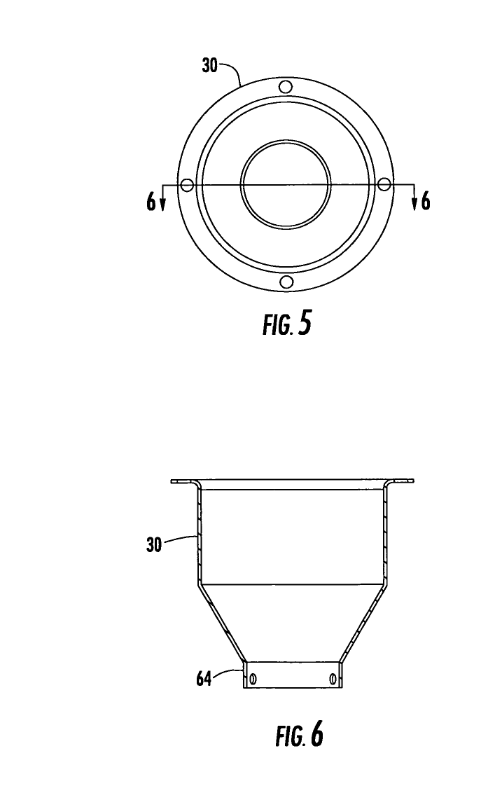

FIG. 4 shows an example of upper section 20 in more detail. Nozzle entry 30 is fastened to upper baffle plate 44 and lower baffle plate 46, wind deflector 60, and rain deflector 62 are provided. FIGS. 5-6 show nozzle entry 30 alone. Proximal end 66 of impactor nozzle housing 32, FIGS. 7-9 is connected to distal end 64 of nozzle entry 30, FIG. 6. Impactor nozzle housing 32 includes single 0.437″ channel 68 for receiving one nozzle jet of the set of jets 50a-50d, FIGS. 2-3. Flange 70, FIG. 11 of nozzle jet 50c properly positions the distal end 72 of nozzle jet 50c from impact plate 38 for a flow rate of 5 liters per minute through nozzle entry 30, FIGS. 4-6 and jet 50c, FIG. 11. This flow rate is lower than the 16.7 liters per minute flow rate of standard prior art sampler systems reducing the power requirements of pump 19, FIG. 1 and allowing the use of system 10 at higher elevations and at remote sites where AC power is not available. Solar power or batteries, for example, may be used to power sample unit 18.

FIGS. 10-11 show in more detail impactor nozzle housing 32 removably connected to lower section 22 including impaction chamber 34 in fluid communication with exit conduit 74 via outlets 36a-c, FIG. 3. Only exit conduit 36a is shown in FIG. 11. Exit adapter 76 interconnects exit conduit 74 with filter unit 16, FIG. 1.

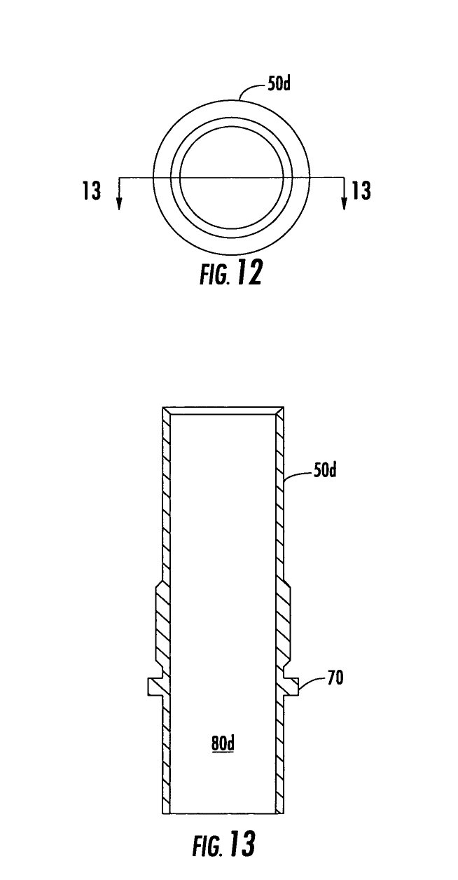

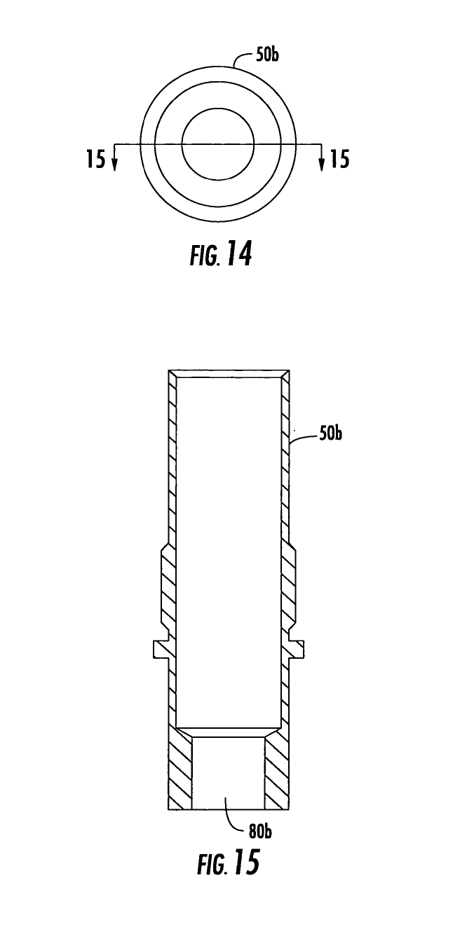

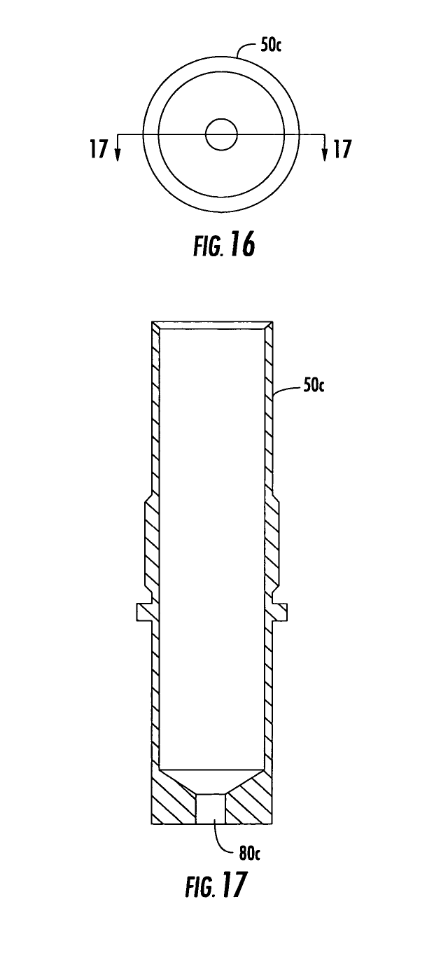

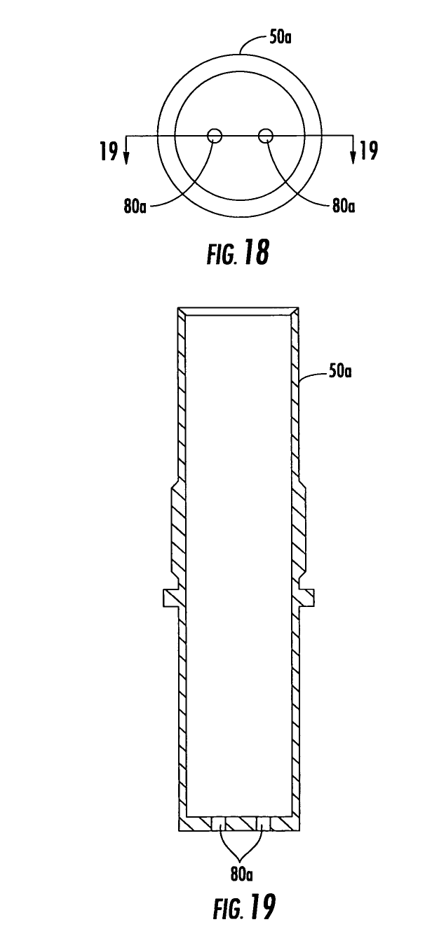

FIGS. 12-13 show in more detail an example of aluminum PM 17 or TSP nozzle jet 50d with 0.375″ orifice 80d. FIGS. 14-15 show in more detail an example of PM 10 nozzle jet 50b with 0.263″ orifice 80b. FIGS. 16-17 show in more detail an example of PM 2.5 nozzle jet 50c with 0.106″ orifice 80c. FIGS. 18-19 show in more detail an example of PM 1 nozzle jet 50a with two 0.047″ orifices 80a spaced 0.168″ apart.

The result is an ambient particulate sampler assembly which can be fitted with different size nozzle jets by the user or manufacturer allowing the user to selectively choose which particulate measuring criteria best suits the user's requirements. The sampler assembly of this invention is accurate, tested, and simple in design, also inexpensive to manufacture. Reconfigurable ambient particulate sampler 10, FIG. 1 is effected by an omnidirectional inlet assembly 12 with an upper section 20 removable from lower section 22 and a set of different size nozzle jets 50a, 50b, 50c, and 50d, FIGS. 2-3 insertable in impactor nozzle housing 32 by the user allowing the user to selectively choose which particulate measuring criteria best suits the user's requirements.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims. For example, other nozzle jets different from or in addition to the nozzle jets described herein may be provided to the user.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An ambient particulate sampler assembly comprising:
an upper section including a nozzle entry and an impactor nozzle housing accommodating a single nozzle jet;
a lower section removable from the upper section and including an impaction chamber with one or more outlets; and
a set of different size nozzle jets insertable in the impactor nozzle housing allowing a user to selectively choose a particular measuring criteria.

2. The assembly of claim 1 further including a sample unit connected to the lower section.

3. The assembly of claim 2 in which the sample unit includes a vacuum source for drawing ambient gas into the upper section at a flow rate of 5 liters per minute or approximately 5 liters per minute.

4. The assembly of claim 1 in which the upper section includes a top plate baffle spaced from a lower baffle plate.

5. The assembly of claim 1 in which the lower section impaction chamber includes three outlets.

6. The assembly of claim 1 in which the lower section impaction chamber includes a water conduit.

7. The assembly of claim 6 further including a water trap connected to the water conduit.

8. The assembly of claim 1 in which the plurality of nozzle jets include a TSP nozzle jet, a PM 10 nozzle jet, a PM 2.5 nozzle jet, and/or a PM 1 nozzle jet.

9. An ambient particulate sampler assembly comprising:
an upper section including a nozzle entry and an impactor nozzle housing accommodating a single nozzle jet;
a lower section removable from the upper section and including an impaction chamber including one or more outlets; and
a set of different size nozzle jets insertable in the impactor nozzle housing by the user or manufacturer, said set including a TSP nozzle jet, a PM 10 nozzle jet, a PM 2.5 nozzle jet, and/or a PM 1 nozzle jet.

10. An ambient particulate sampler inlet assembly comprising:
an upper section accommodating a single removable nozzle jet;
a lower section removable from the upper section and including an impaction chamber; and
a plurality of different size nozzle jets insertable in the upper section.

11. The inlet of claim 10 in which the upper section includes a top plate baffle spaced from a lower plate baffle.

12. The inlet of claim 10 in which the lower section impaction chamber includes three outlets.

13. The inlet of claim 10 in which the lower section impaction chamber includes a water conduit.

14. The inlet of claim 13 further including a water trap connected to the water conduit.

15. The inlet of claim 10 in which the set of nozzle jets include a TSP nozzle jet, a PM 10 nozzle jet, a PM 2.5 nozzle jet, and/or a PM 1 nozzle jet.

16. The inlet of claim 10 in which the upper section includes a nozzle entry which receives an impactor nozzle housing including a channel for receiving a nozzle jet.

17. An ambient particulate sampler inlet assembly comprising:
an upper section accommodating a single removable nozzle jet;
a lower section including an impaction chamber; and
a set of nozzle jets including a TSP nozzle jet, a PM 10 nozzle jet, a PM 2.5 nozzle jet, and/or a PM 1 nozzle jet each insertable in the upper section.

18. An ambient particulate sampler assembly comprising:
an upper section including a nozzle entry connected on one end to a baffle plate assembly and connected on the other end to an impactor nozzle housing;
a set of different size nozzle jets removably insertable in the impactor nozzle housing;
a lower section removably connected to the impactor nozzle housing and defining an impaction chamber in fluid communication with an exit conduit; and
a sampler unit connected to the exit conduit of the lower section and including a pump for drawing ambient gas into the upper section at a flow rate of 5 liters per minute or approximately 5 liters per minute.

19. The assembly of claim 18 further including a filter between the sampler unit and the exit conduit of the lower section.

20. The assembly of claim 18 in which the set of different size nozzle jets includes a TSP nozzle jet, a PM 10 nozzle jet, a PM 2.5 nozzle jet, and/or a PM 1 nozzle jet.

21. The assembly of claim 18 in which the baffle plate assembly includes a top plate baffle spaced from a lower baffle plate.
